(19) United States
(12) Patent Application Publication
(10) Pub. No.: US 2025/0117447 A1
(43) Pub. Date: Apr. 10, 2025

(54) SYSTEM AND METHOD FOR METAMAKING AND METAVERSE RIGHTS MANAGEMENT

(71) Applicants: THE JOHNS HOPKINS UNIVERSITY, Baltimore, MD (US); BOARD OF TRUSTEES OF MICHIGAN STATE UNIVERSITY, East Lansing, MI (US)

(72) Inventors: Gregory FALCO, Baltimore, MD (US); Joshua SIEGEL, Novi, MI (US)

(73) Assignees: THE JOHNS HOPKINS UNIVERSITY, Baltimore, MD (US); BOARD OF TRUSTEES OF MICHIGAN STATE UNIVERSITY, East Lansing, MI (US)

(21) Appl. No.: 18/730,004

(22) PCT Filed: Jan. 20, 2023
(86) PCT No.: PCT/US2023/011264

§ 371 Date: Jul. 18, 2024

Related U.S. Application Data
(60) Provisional application No. 63/301,771, filed on Jan. 21, 2022.

(51) Int. Cl. G06F 21/10

(52) U.S. Cl. CPC G06F 21/101

(57) ABSTRACT

A method of creating a virtual asset based on an existing real-world asset is disclosed. The method includes digitally sequencing the existing real-world asset to create a digital sequence of the real-world asset; tokenizing the digital sequence of the real-world asset to create a tokenized digital sequence; associating the tokenized digital sequence with the real-world asset; and creating a title of ownership of the tokenized digital sequence.

### CROSS-REFERENCE TO RELATED APPLICATIONS

This application is the national stage entry of International Patent Application No. PCT/US2023/011264, filed on Jan. 20, 2023, and published as WO 2023/141286 A1 on Jul. 27, 2023, which claims the benefit of U.S. Provisional Patent Application No. 63/301,771, filed on Jan. 21, 2022, all of which are hereby incorporated by reference herein in their entireties.

### FIELD

This invention relates generally to the metaverse, and more particularly to a system and method for metamaking and metaverse rights management.

### BACKGROUND

A metaverse is a network of digital technologies enabling broad interconnection and the creation of virtual worlds that parallel and augment the physical world. Within a metaverse, avatars or other digital agents may interact, e.g. in extended or mixed reality. In the coming years, the concept of the metaverse is poised to mirror physical systems and create new means of engagement and interactivity infeasible in the physical world. As individuals and organizations increasingly seek to live, at least in part, in a metaverse, the ability to “take things with you” to a metaverse, and to manage these things, will become critically important. This is complicated by the fact that commercial interests are intent on creating siloed metaverses rather than one single metaverse.

### SUMMARY

According to examples of the present disclosure, a method is disclosed that comprises acquiring sensor data from a real-world tangible asset; processing the sensor data that is acquired to generate one or more feature sets that are representative of one or more attributes of the read-world tangible asset; and creating a unique digital asset that mirrors the one or more attributes of the real-world tangible asset.

Various additional features can be included in the method including one or more of the following features. The sensor data is acquired from one or more proprioceptive sensors, one or more exterioceptive sensors, manually entered data, derived identifiable digital data, metadata, or combinations thereof. The processing comprises performing one or more frequency analysis processes, one or more cepstrum analytic processes, one or more filtering processes, one or more wavelet analysis processes, one or more spectral analysis processes, one or more image processing, one or more computer vision processing, or combinations thereof. The one or more feature sets are resistant to perturbations so that one or more unique landmarks associated with the one or more attributes of the real-world tangible asset are uniquely identifiable. The one or more unique landmarks are extractable without prior knowledge or human intervention. The unique digital asset comprises a digital ledger that comprises information related to ownership of the unique digital asset and the real-world tangible asset. The unique digital asset comprises a digital ledger that comprises information related to one or more rights provided by the unique digital asset and the real-world tangible asset. The unique digital asset is a non-fungible token. The digital ledger comprises a blockchain. The method can further comprise using the unique digital asset in one or more metaverses or one or more virtual reality environments. A computer system is disclosed that performs the method of any of the claims. A non-transitory computer-readable medium is disclosed that stores instructions that a computer system can perform any of the methods of the claims as described herein.

According to examples of the present disclosure, a method of creating a virtual asset based on an existing real-world asset is disclosed. The method comprises digitally sequencing the existing real-world asset to create a digital sequence of the real-world asset; tokenizing the digital sequence of the real-world asset to create a tokenized digital sequence; associating the tokenized digital sequence with the real-world asset; and creating a title of ownership of the tokenized digital sequence. The real-world asset is a tangible real-world asset or a non-tangible real-world asset. The digital sequence of the real-world asset comprises information that classifies, characterizes, and uniquely identifies the real-world asset to a computer system. The digitally sequencing comprises acquiring one or more of the following: vibroacoustic signals from the real-world asset, visual signals from the real-world asset, radio signals from the real-world asset, proprioceptively-sensed signals from the real-world asset, or exterioceptively-sensible signals from the real-world asset, or digital metadata capable of uniquely describing the system, particularly in the case of a non-tangible asset. The tokenizing the digital sequence comprises crating a digital or cryptographic hash of the digital sequence of the real-world asset. The title of ownership is transferrable between computer systems or metaverses. A computer system that performs the method of any of the claims as described herein. A non-transitory computer-readable medium that stores instructions that a computer system can perform any of the method of the claims as described herein. A method according to any of the examples described herein. A computer system configured to execute any the examples described herein. A computer-readable medium storing instruction that a computer system executes to perform any of the examples described herein.

Advantages of the embodiments will be set forth in part in the description which follows, and in part will be understood from the description, or may be learned by practice of the invention. The advantages will be realized and attained by means of the elements and combinations particularly pointed out in the appended claims. It is to be understood that both the foregoing general description and the following detailed description are exemplary and explanatory only and are not restrictive of the invention, as claimed. The accompanying drawings, which are incorporated in and constitute a part of this specification, illustrate embodiments of the invention and together with the description, serve to explain the principles of the invention.

### BRIEF DESCRIPTION OF THE FIGURES

FIG. 1 shows devices running metaverse applications engaging directly with one or more metaverses according to examples of the present disclosure.

FIG. 2 shows the left key and right key have the same cut pattern; the left key is considerably more worn-down.

FIG. 3 shows an identity and a metadata comprise the CPS sequence; the metadata bundle itself comprises both implicit and explicit provenance and observed measures for the system's current state according to examples of the present disclosure.

FIG. 4 shows that when a system is mirrored, it first uses a generalized model and over time, models are adapted and leaned to mirror critical parameters with minimal resources according to examples of the present disclosure.

FIG. 5A shows the mirrors (center) represent Data Proxies within a Cloud computing environment according to examples of the present disclosure. The Proxy architecture allows diverse systems and applications to co-mingle with limited resource expenditure and few areas for interstitial weakness. FIG. 5B shows proxies that store sparse representations of systems in remote computing environments, whereas Digital Twins offer higher resource intensity, more faithful mirrors according to examples of the present disclosure.

FIG. 6 shows a distributed ledger mirrors each digitized systems' CPS sequence, which in turn may be resolved to a specific Data Proxy mirroring system parameters according to examples of the present disclosure.

FIG. 7 shows a representative interaction among asset owners and users of asset data according to examples of the present disclosure.

FIG. 8 shows a method according to examples of the present disclosure.

FIG. 9 illustrates example components of a device that may be used within and/or by the various examples described.

### DESCRIPTION

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

The following embodiments are described for illustrative purposes only with reference to the Figures. Those of skill in the art will appreciate that the following description is exemplary in nature, and that various modifications to the parameters set forth herein could be made without departing from the scope of the present invention. It is intended that the specification and examples be considered as examples only. The various embodiments are not necessarily mutually exclusive, as some embodiments can be combined with one or more other embodiments to form new embodiments.

According to examples of the present disclosure, the coupled concepts of “metamaking” and a “metaverse clearing house” are described below. Metamaking is the concept of taking tangible and intangible, and/or non-tangible assets from outside the metaverse and recreating these in one or more metaverses. In the context of this disclosure, intangible and non-tangible are used interchangeably to mean the same things. However, creating a digital representation of an extra-metaverse asset is just the first step in engaging and interacting with that asset within a metaverse. To maintain the financial viability of a metaverse, these assets must be effectively managed, e.g. to prevent double selling. A “metaverse clearing house” (MCH) is a rights attribution, management, and supervision system pertaining to assets moving into, out of, within, or among one or more metaverses.

These concepts work together in that metamaking an asset allows an individual, group, or organization to take a tangible or intangible asset outside of the metaverse, and create some representation of that asset in the metaverse. The MCH allows individuals, groups, or organizations to claim or manage some right or rights to that asset, while providing configurable degrees of accountability, transparency, control, and visibility into those rights. The MCH might be likened to a digital, meta-multiverse register of deeds for all assets, tangible or not.

Metamaking allows individuals, groups, and organizations to take a new or existing asset and recreate it in one or more metaverses. Metamaking has three unique, differentiating elements that may be protectable: sequencing, hashing, and system matching. The metaverse clearing house, which assigns title and rights to metamade assets, has the unique and potentially-protectable element of inter- and intra-metaverse title management.

Sequencing is how a system is digitally-characterized: in the case of a tangible asset, observable parameters are measured to classify, characterize, and then uniquely-identify a system. This may take the form of vibroacoustic signals, visual signals, radio signals, or some other proprioceptively- or exterioceptively-sensible signature. In the case of a non-tangible asset, the asset may be characterized by making elements of that asset digitally-interpretable, e.g. digitizing a textual description of a concept. These digital artifacts may be characterized, e.g. through natural language processing or computer vision techniques, to classify, characterize, and uniquely-identify that asset. Assets are sequenced when a system is first metamade, and at regular intervals throughout the asset's life to ensure that the metaverse representation and real-world asset appropriately mirror one another and stay linked over time, even as the asset state evolves through use and wear. Sequencing, whether run on the instrumented system or a peripheral system, may optionally be used as proof of work to support updating the DHT.

Once a system is identified, it is assigned a globally-unique digital identifier. Examples of such identifiers include QR codes, RFID tags, or automotive VINs. Due to more diverse and more numerous assets, hashing for the metaverse will inherently have to be more unique to minimize collisions: a globally-unique, non-reversible hash for assets is created that comprises a serialized identification for a system as well as system metadata, e.g. provenance. As an example: a vehicle is uniquely-identified from a VIN, but VINs can be copied on high-value vehicles. Creating an identifier that merges VIN with location with past location history and odometer value will by design be harder to spoof. Hashing for the metaverse will merge invariant and state-indicative elements together in a metadata bundle that uniquely identifies a system at a particular contextual point (e.g. in time, space, operating status, wear . . . ).

When an asset is metamade, a digital version of that asset will be created and automatically linked to the original asset. Today, system matching requires human intervention to work well: Digital Twins are tailored to specific systems and then matched to real-world assets, often by hand. Metamaking is an automatic, adaptive process: metaverse assets are created on-the-fly with models that match specific systems without human intervention. This is possible because of the degree to which sequencing characterizes a system; with such intensive characterization, the metaverse model of an asset might be built without human intervention and then automatically paired with a specific instance of a non-metaverse asset. Think of system matching like hyper-sensitive face recognition for the world.

The Metaverse Clearing House provides for a title management system that serves as a “gateway” for metamade assets into, out of, within, and among metaverses. The title management system assigns a title and rights to each asset and acts as a transaction layer, with all assets and transactions passing through it.

As with other DLT-enabled technologies, metamaking an asset may require a gas fee; a coin will be necessary to collect this. The DLT behind metamaking and the MCH will be an ERC20 run in parallel to a test network which will have no gas requirement; this will allow the system to be transitioned from the test network to an actively-used chain. These chains will store hashed metadata relating to metamade asset identity and ownership.

In an alternative business model, there may be no gas fee for an initial hash, and only a fee for attaching extended attributes (metadata/history) to the hash—the “first hash is free.”

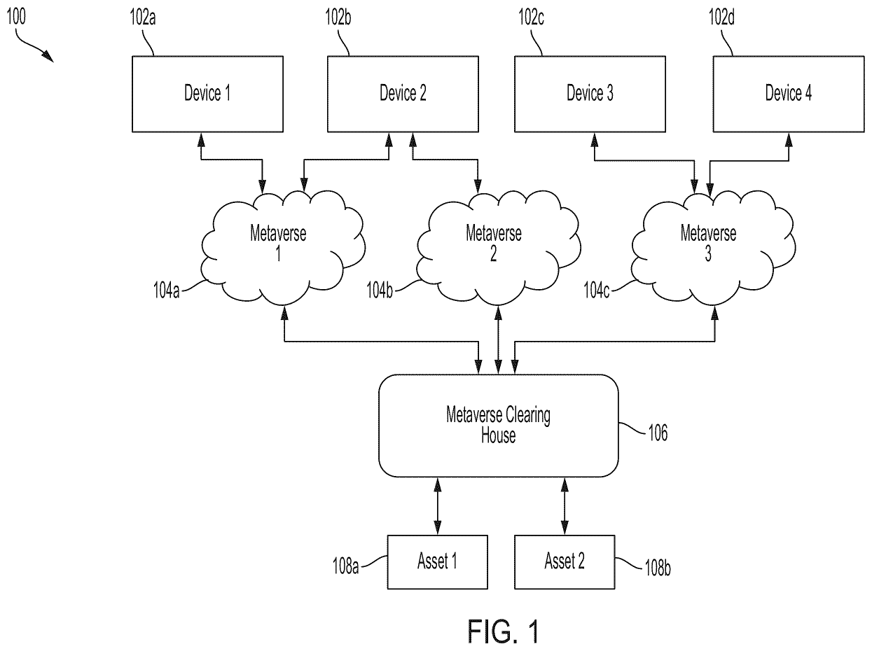

FIG. 1 shows a system 100 where devices running metaverse applications engaging directly with one or more metaverses according to examples of the present disclosure. Devices, such as device 1 102a, device 2 102b, device 3 102c, and device 4 102d, running metaverse applications engage directly with one or more metaverses, such as metaverse 1 104a, metaverse 2 104b, and metaverse 3 104c; assets, such as asset 1 108a and asset 2 108b, are sent to one or more metaverses through the Metaverse Clearing House (MCH) 106. When metaverses interact, they do so through the MCH. There is no direct connection among devices and assets, and no direct connection among metaverses. This improves security and prevents scenarios such as those where an asset might be duplicated and sold twice in two different metaverses without authorization.

### Value Proposition

Our value proposition is that “you can take it with you (to the metaverse)!”

In the future, buying or otherwise coming into ownership of an asset will bring with that transaction a parallel transaction in the metaverse. In this way, individuals will own an asset as well as a meta-version of that same asset. This may be thought of in the same vein as a parcel of land having with it mineral or other property rights: the real-world and meta-world of an asset may be coupled closely, or disaggregated and parceled out independently in each world.

A car, therefore, may have a title and property rights in the real-world, while access to the metaverse version of that same car may be sold from the car's original owner to another rights holder. Alternatively, the owner may divide rights into shares, such that the digital version of the car might have read-only permissions for multiple stakeholders, but be writable or transferable only to one individual.

Allowing assets from the real-world to be mirrored in the metaverse will create significant opportunities for the creation of a parallel economy, perhaps based on digital currency.

### Example Use Scenarios

In one example use case, an individual might buy a historic vehicle in the physical world and choose to metamake that vehicle in order to enjoy the benefits of ownership in the metaverse (e.g. showcasing the vehicle digitally, or loaning rights to the physical vehicle, or paperless ownership transfers). The owner of the vehicle would digitize ownership documents and then scan the vehicle, using cyberphysical sequencing (visual, vibroacoustic, radio, or other characterization of the system) to create a digital representation of that system. The system would then be hashed to provide a globally-unique identifier, and the physical and metaverse system would be linked automatically such that the physical and metaphysical asset over time continue to reflect one another. Once metamade, the vehicle's digital identity would then be manageable within the MCH; the vehicle's ownership could be validated such that the same car cannot be multiply-sold, and the metaphysical car could be moved from one metaverse to another metaverse associated with the MCH (affiliated metaverses might be termed as having “metareciprocity” to reflect the use of a common hashing, matching, and title management system). In this manner, an individual may automatically metamake a metarepresentation of their physical assets and then manage their rights to that physical asset at a global scale, increasing the potential use cases for and value of the metaverse.

Other assets might be sold in the physical world explicitly to be metamade. These assets might instead be created in the metaverse e.g. through scanning a QR code, Digimark image, or RFID tag.

In another example use case, an intangible concept may be “metamade;” in this case, it could be a copyright, a patent, or a concept. With the example of a patent, patent licenses ascribe to the license holder certain rights; today, it is difficult look at a patent and know who holds license to that patent, and what rights that license holder may have. A patent might be “metamade” by associating the patent claims with a public distributed ledger, and the patent assignee would gain certain rights to that patent upon its passing through the MCH. The patent assignee could then assign and manage rights through the MCH, allowing licenses to be easily managed and optionally publicly-visible. Other non-tangible assets, such as concepts or even businesses, might be similarly managed.

### Business Model

There are many ways in which to monetize the concepts disclosed herein. Consumers can be brought into the metaverse fold as paying customers in the following ways:
1. Paying to metamake an asset
2. Getting an asset metamade for free, and then paying to attach and/or update metadata
3. Paying license fees upon transferring and/or exercising certain rights
4. Paying a subscription or registration fee

Industry, including metaverse hosts, can support metamaking financially by:
1. Joining a consortium as a paying member
2. Profit sharing on microtransactions, ad revenue, or service fees
3. Providing computational resources and/or gas fees

A university can monetize metamaking through capability-building and working towards the development of a center for excellence through which to target government, foundation, and industry funding.

Alternatively or additionally, a university could serve, for a fee, as a permissioned governor to supervise the distributed hierarchical ledger. This would allow the university to charge transaction fees associated with metamaking a system and transporting that system across metaverse boundaries, while providing consumers with added trust that an unbiased third party is supervising all transactions. Fees could be increased for special services, such as increased transaction scrutiny or expedited processing.

In this scenario, an individual might engage with the university directly as a broker, or alternatively might work with a third-party broker/concierge to engage with the university to facilitate a more user-friendly and less-technical transaction (this is similar to how GS1 sells UPC and RFID namespace, and brokers buy namespace and sell small portions to smaller companies). The university would be the only direct line of communication with the MCH.

This creates a secondary market for brokers to facilitate transactions, e.g. brokers who operate auction houses or who work in peripheral industries to sell additional value-add services such as insurance.

Cyber-Physical systems (CPS) have complex lifecycles involving multiple stakeholders and an opaque software and hardware supply chain; what is requested and received may well differ. There is an opportunity to build a cyberphysical titling process offering universal, large-scale traceability and the ability to differentiate systems based on unique identity and provenance characteristics. Today, RFID tags and barcodes address some of these needs, though they are easily manipulated due to non-linkage with an asset's intrinsic and extrinsic characteristics. A cyberphysical sequencing is used that engages machine learning characterization and a light-weight distributed ledger as a low-cost and pervasive means of adding track-and-trace capabilities to any asset tying a system's physical identity to a unique and invariant digital identifier. CPS sequencing offers benefits similar to Digital Twins' for identifying and managing the provenance and identity of an asset throughout its life with far fewer computational and other resources. This capability will be core to a CPS Genome Project that will transform supply chain assurance in a scalable and cost-effective manner.

Across domains, manufactured and assembled system complexity is increasing. Constituent components require compliance with stringent specifications, must have low defect rates, and increasingly require known provenance relating to origin and interaction histories. At the same time, economic and other constraints affecting production and assembly may necessitate involving diverse and untrusted vendors: a vehicle's parts may be made abroad and assembled domestically, while a medication might be compounded in one country before being shipped to another for packaging and a third for distribution. Power generation plant components might be manufactured globally but require certification in the country of use, while electronics manufacturing for a globally-distributed device may require trust-related integrated circuits to be provided and validated by a single-source vendor.

Diverse and distributed supply chains invite substantial risk of counterfeit, compromise, or non-compliance. Providing insight into component origin, provisioning and life before assembly has the potential to make resulting systems more robust, resilient, and broadly usable than is feasible today. Consistent validation of the trusted identity and integrity of a system is necessary to support system tracking, supervision management, and transferability to mitigate this risk, particularly for critical applications.

Asset supervision may be simple: high assurance systems like space vehicles have robust, metadata-abundant supply chains. In other cases, system, sub-assembly, and component mapping is more difficult. Assembled automobiles, for example, belong to a global registry for Vehicle Identification Numbers that supports asset supervision and management—but outside of engines and structural elements, components themselves are may not be universally serialized or tracked after sale. The smaller and lower cost a component, the less likely it is to be uniquely identifiable. This poses challenges particularly as low-cost electronics increasingly support driver assistance and other safety-critical technologies. The issue of non-unique identification and non-traceability is worsened for smaller, lower-cost assets such as consumer electronics and appliances, where the cost of serialization and immutable identification is high relative to the cost of the component, assembly, or system.

Irrespective of the instrumented system or component, broad asset identification, traceability, supervision, and management offer the potential for substantial safety, economic, reliability, and usability benefits in addition to providing information necessary for supply chain optimization. These capabilities are best taken advantage of in a digital context; digital systems offer heightened transparency and ease of data access and sharing relative to physical-only approaches, with the potential to scale substantially. For example, tracing individual medical pills electronically would allow for manufacturers, doctors, and patients to understand the origin and chain of custody of a pill and regularly enforce compliance with medical prescriptions, whereas tracing a bottle of pills on a written ledger only allows a pharmacist to verify that the pills are ostensibly of sound origin and have or have not been distributed to the appropriate individual at the right time.

In view of the unmet need to instrument smaller and lower cost assets digitally, there are safety, security, economic, and social advantages in turning every physical system into uniquely differentiated Cyber-Physical System (CPS) comprehensively, efficiently, and with minimal manual intervention. System classification, characterization, and identification techniques built upon mechanical and software engineering capabilities have the potential to extract differentiating features for diverse systems, thereby facilitating automated system identification. Pairing unique identifiers with an instance-specific, immutable digital identifier associated with lightweight asset mirrors can enable automated non-repudiable track-and-trace capabilities supporting critical applications including smart supply chain management, digitalized and networked logistics systems, AI-backed logistics decision support systems, digital forensics, and safety-critical Healthcare and Industry 4.0 applications.

As described herein, a universal, automated asset digitization system is disclosed that is suitable for providing enhanced supply chain, component provenance, and system state data and explore how these capabilities will contribute to a future in which universal, low-cost and low-touch asset mirroring can enable the benefits of pervasive supply chain unrealizable with contemporary technology. The opportunity for pervasive universal asset identification is identified, and then the technical elements used to enable such enhanced asset management is discussed. A representative components and architecture for a lightweight system for asset tracking combining these affordances in a holistically-optimized manner is then discussed.

Traditional supply chain management techniques require frequent manual intervention or operate on systems and assets of limited diversity, challenging their ability to massively scale. Human intervention takes the form of manual counts or supervised automated scanning, data entry, model creation, and digital system supervision and management. Creating a sustaining and scaleable asset management solution necessitates the development and deployment of novel automated system identification techniques, resource-light pervasive digital mirroring capabilities, and secure and effective large-scale mirror management techniques.

Highly-specific system identification is essential to the tracking and traceability of individual system instances without manual intervention. Automated identification, which uses software to differentiate among system types and instances, relies primarily on two algorithmic processes: classification, which identifies the system type, and characterization, which provides quantitative and qualitative measures of a specific system's state. Classification narrows a computer's need to search a broad range of assets to identify a system; this of this like playing “20 Questions”—few attributes greatly narrow the number of possible systems. Once the search area is focused, precise system characterization may be used to uniquely identify an instance of a particular system class; for example, once a computer knows that an asset to be identified is a car, it can look at the license plate to resolve the car to a particular instance. Another example using joint classification and characterization for unique identification is facial recognition: first, a human is identified, then, a face, and then facial landmarks are used to identify a specific person. In the case of identifying an appliance, an algorithm might first determine that the sound it hears must come from a machine with a motor, then a washing machine, then a washing machine on the spin cycle—and from subtle noises reflective of the belt's wear and a slight imbalance in the manufactured drum, know where that particular machine is located and its serial number.

Classification and characterization may use input data from proprioceptive (self-measuring) or exterioceptive (externally-measuring) sensors such as those found in smart phones [1]. For example, a smartphone microphone might be used as an extereoceptive sensor to identify a particular car engine [1] that can be mapped to unique Vehicle Identification Number. Or, a car may use proprioceptive accelerometers to identify the serial number of a tire that is part of an imbalanced wheel and tire assembly [1]. A bandage might be identifiable to an exterioceptive sensor such as a laptop's webcam using a technique such as DigiMark [2], or with sufficient resolution, through “witness marks” that serve as visual fiducial indicators left behind unintentionally as a manufacturing artifact.

Once captured, sensor data are processed, often using techniques such as frequency analysis, cepstrum analysis, filtering, wavelet analysis, and other approaches such as computer vision. These techniques generate robust features that are resistant to small perturbations such that algorithms can easily and reliably identify unique landmarks without model overfit, even as the system's state evolves. These landmarks and features may be extracted without prior knowledge or human intervention [1].

The algorithmic foundations for classification and characterization vary by domain and are well-established in literature. Importantly, classification and characterization algorithms are transferrable across systems, contexts and domains.

Detection of micro-scale faults and imperfections is suitable for unique instance identification for some asset classes. With broad model coverage, automated system identification may therefore be used to uniquely serialize diverse physical systems without human intervention. This would eliminate the substantial human bottleneck of asset identification, serialization, and matching with digital representations, thereby supporting the tracking and traceability of larger-scale, more diverse systems than presently possible.

Interconnected CPS present opportunities for large-scale cross-context data collection, analytics, and actuation that augment, extend, and complement the supply chain advances enabled by pervasive digital identification. As a result, CPS increasingly represent physical systems mirrored within remote computing endpoints.

One way of mirroring system parameters is using a Digital Twin (DT). A DT is a virtual entity connected to a real world entity comprising three elements: the twin itself comprises the digital “identity” and instance of a system, the connection links the digital with the physical, and then a model mirrors the physical entity digitally using reflective state-space and metadata representations. DT's can be diversely characterized but in general aim to richly mirror a system—capturing useful data at the expense of significant computational, energetic, and network resources. Often, DT's and physical systems are matched and modelled manually, the effort of which limits their scale. Reducing resource requirements and automating model creation and matching has the potential to enhance digital system mirrors' utility in supply chain and other applications by providing enhanced full-chain insight into system state, performance, and context among larger networks.

Data Proxies offer an alternative solution to Digital Twins that address resource and modelling challenges facing Twins' large-scale adoption. Like Twins, Proxies are rich representations of physical or other systems. Unlike Twins, Proxies use system models to recreate faithful representations from sparse—and therefore, resource—light-data. Compared with DT's, Proxies are more resource efficient and their execution within remote computing environments supports enhanced and scaleable context-aware security capable of protecting both data streams and diverse, connected systems. In economic terms, while Proxies seek a “pareto solution” to Digital Twinning that attains a high-fidelity mirror with significantly reduced resource requirements.

Proxies may also be augmented with additional data types: supply chain and logistics management, for example, requires understanding not only the what, where, and how of a system at present time, but also system and component provenance. Provenance may inform judgements on trustworthiness and accuracy of a system, based on a history of data acquisition, modification, maintenance, and custody (but not ownership). Data Proxies can benefit substantially from the capture and service of metadata.

Data provenance is a well-established concept in some domains, but is lesser-explored in CPS. Today, provenance is difficult to share efficiently—and must be thoughtfully designed and digitally represented so as not to tax a network. At the same time, the provenance mechanism must be secured to assure full-chain trustworthiness. A simple provenance model encapsulates the source of data, their capture and transmission mechanisms—and intermediate handlers—and modifications occurring at points between the sensor and the end-user or end-use application.

There have been efforts to standardize provenance reporting for data in connected devices, e.g. ECMA TR/110 which defines reportable metadata as including peripheral sensor details, identification of the physical variant of a sensing device, information derived from the clock, and geospatial data. In the context of logistics and supply chain, additional parameters may be mirrored.

If systems are uniquely and automatically identified as described above, classification results may be used to create and pair systems with appropriate mirroring models for recreating and representing the system's state and metadata using few computational resources. In this manner, low-touch physical system mirroring will support automated, detailed asset tracking and supply chain management as well as broader distributed system applications and optimizations.

Digital Twins are often mirrored within proprietary databases using locked-down Application Programming Interfaces (APIs) to facilitate access. These Twins mirror certain system types and enable particular applications and use cases. In comparison, Distributed Ledger Technology (DLT) offers advantages related to scalability, ease of access, and security. DLT is a class of decentralized multi-party systems that operate synchronously. There are several types of DLT, notably blockchain. Blockchain is a data structure that consists of blocks of data linked in a chain by cryptographic hashes.

DLT enables a secure means for consensus-driven recording, even in adversarial environments where malicious actors attempt to change values or disrupt the ledger. Data may include asset identifiers, titles, metadata, or most any digital information in readily-accessible or encrypted form. To successfully alter the ledger, a malicious actor must control 51% of processing power comprising the ledger's mining infrastructure; large-scale attacks are unlikely.

Blockchain's uses have grown since Bitcoin, a decentralized payment system, and Ethereum, a means for establishing smart multi-party contracts, were introduced. Ethereum's smart contract platform allows software developers to build applications such as title tracking or smart contracts. Other applications secure and validate software updates, log readings and system identities, manage credentials and data, and provide authentication. Blockchain has also been used to store and secure lifecycle data, service records, and accident histories and reconstruction from supply chain through end-of-life.

A recently-popular DLT application is Non-Fungible Tokens (NFTs). Unlike other assets, such as Bitcoin, NFTs are non-fungible: the digital identifier is linked inextricably to a particular instance of a “thing.” DLT and NFTs therefore have the potential to assign immutable, non-revocable identifiers to specific digital and physical things, allowing the creation of a mass-scale set of identifiers for diverse systems. These identifiers can be linked not only to the identity of a physical thing, but also to all other attributes of a Digital Twin or Data Proxy-connecting the system mirror itself to a pervasive and secure universal identifier accessible to anyone with appropriate credentials.

With the combination of DLT and NFTs with Digital Twins, Data Proxies, and/or provenance metadata (as described below, unique digital identifiers may be tied inextricably to specific physical and other system instances—creating a faithful, secure, and broadly-accessible mirror of the real world in a digital context. Individually, these technologies address challenges and unmet opportunities in enabling digital supply chain and logistics; combined thoughtfully, these technologies will underpin a system supporting pervasive and universal-scale system mirroring and supervision that will lead massive societal benefit.

As the above discussion of the elements of enhanced asset management demonstrates, there have been substantial efforts in the areas of automatically identifying, efficiently mirroring, and securely and scalably storing records for physical assets—but such elements have not been combined for the mirroring of diverse systems, at scale, with high granularity and minimal human involvement. The holistic development of a unified and automated digital asset management solution could enable novel supply chain and logistics optimization capabilities, as well as support the development of data-enhanced management and supervision applications. A holistically-designed solution is discussed merging these enabling elements in support of the complete and comprehensive mirroring of all manner of physical and other systems and their constituent components.

For some use cases, elements of this holistic approach exist-barcodes or RFID tags encode information that may uniquely identify a system to enable track-and-trace capabilities, while a Vehicle Identification Number may encode information about the origin of that vehicle (country of manufacture, options, etc.). However, these existing techniques do not rely on system intrinsic metrics to establish identity—a label may be separated from the system, presenting questions of security and trust. Further, tagging and data entry are often manual or otherwise limited to systems that have low-variability to facilitate automatic serialization. No extant approaches combine unique, invariant identification with observable and low-mutability origin and provenance markers to enable mass-scale asset tracking and management.

In presenting a vision for a system addressing these unmet opportunities, a parallel to biology is made: in the case of a bioorganism, the genome determines the composition of the organism as well as provides a unique identifier, while epigenetics codifies the way in which environmental conditions and behaviors impact that genome's expression. In a (cyber) physical system, a “physical hash” may offer an analog that invariantly identifies a system and the composition of that system, and its contextual, deterministic “expression” based on the operational lifecycle of the system. In this manner, the physical hash can be used to identify-throughout its lifecycle-particular instances of a system or component.

Just as genomes can be sequenced to provide identifying information and insight into biological systems, a “CPS Genome Project” is described for automatically matching a physical system with a digital representation of that system and instance, enabling security and identity verification and facilitating trusted CPS transactions. Rather than looking at DNA, this Project will evaluate observable physical hashes to identify and evaluate particular systems and comprise a system-specific digital identifier inextricably linked to that specific asset. Features unique to the system may be captured by on-system or ambient sensors. This will enable any physical system, with or without sensing, connectivity, or networking, to become cyberphysical in nature without human involvement. This will facilitate system identification, tracking, supervision, management, and transferability. An instance-specific “metadata bundle” will describe the system or component's particular provenance and lifecycle. The system itself, and its metadata, may be mirrored as a Data Proxy referred to by an immutable DHT for asset management.

Such a system would draw upon elements of proprioceptively- and exterioceptively-sensed system classification, characterization, and identification, a hybridized distributed ledger architecture for communicating the operations of a complex system, and metadata tagging. The thoughtful combination of such techniques with clean-sheet design will support the fast and effective development of CPS sequencing, metadata bundling, and a DLT/NFT technology for mirroring identities and transaction histories robustly at scale. Also resulting from the CPS Genome Project will be a large-scale library of features suitable for classifying, characterizing, and identifying diverse systems with little to no necessary algorithm training.

Classifying a system uses diverse sensors to answer a series of questions, with each subsequent question narrowing the search space. The below excerpt is from http://www.20q.net, when the example subject asset to be tracked is a physical key:
Is it Animal, Vegetable, Mineral, Concept, or Unknown?
Unknown
Is it very large? No
Do you use it at work? Yes
Is it black? Rarely
Can it be used to write? Doubtful
Is it hard? Yes
Does it like to run? No
Can liquids pass through it? No
Would you use it in the dark? Sometimes
Is it very, very expensive? No
Is it round? No
Does it usually have four corners? No Can it be placed on your head? Yes Does it have a hole in it? Usually Does it break if dropped? No
Is it flexible? No
Does it have writing on it? Sometimes
It's probably a key

From 20 questions that can largely be answered from low-cost sensors, the website correctly identified the class of system in question. In the case of the example system embodiment, this information could primarily be observed from a camera external to the key itself-which would ultimately allow the system to be mirrored without any onboard sensing, computation, or connectivity, relying instead of pervasive sensing and computation for instrumentation, analysis, and reporting. Next, the specific system needs to be identified. To do this, some class-specific knowledge may be applied—in this case, it is known that keys wear with use, and the wear on each cut (“witness marks”) can tell us something about the key's history—and its associated lock.

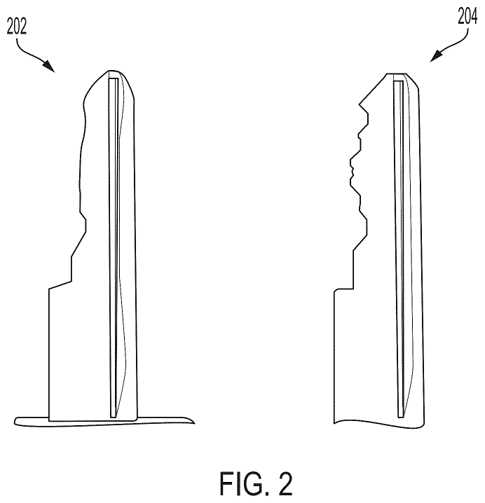

FIG. 2 shows the left key 202 and right key 204 have the same cut pattern; the left key 202 is considerably more worn-down. In the case of two keys that are identical by design but that age differently, such differences can be characterized using the same or different sensors from those that identified the class of the subject asset. Here, vision can be used to assess the relative age and wear of each key, with potential other insights into provenance such as likely material, and based on other visual artifacts, whether the key in question is original or a copy. With sufficient data, the key can be tied to a particular instance of an asset, even if that asset might have many near-identical copies.

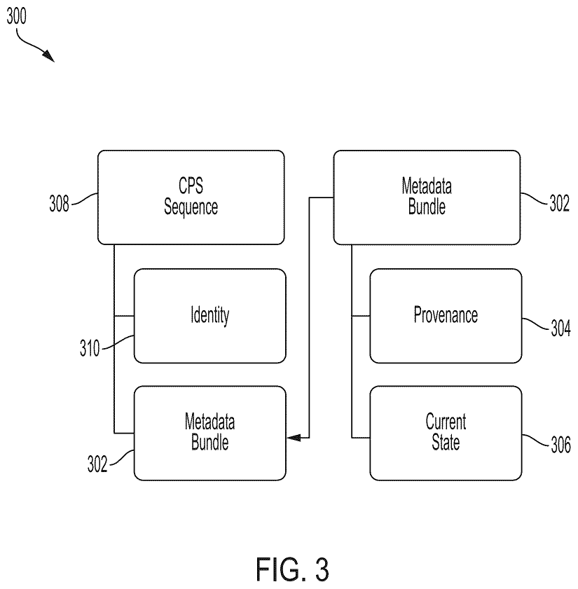

FIG. 3 shows a hierarchical representation 300 of an identity and a metadata comprise the CPS sequence; the metadata bundle itself comprises both implicit and explicit provenance and observed measures for the system's current state according to examples of the present disclosure. Once the key has been uniquely identified, its current state 306 and provenance 304 are combined into a metadata bundle 308. The identity 310, the current state 306, and the provenance 304 then comprise the “Cyberphysical Sequence” (“CPS”) 308 of that asset. The hierarchical relationship among the CPS Sequence 308, Identity 310, the Metadata Bundle 302, Provenance 304, and the Current State 306 (all as determined by pervasive sensing) is represented in FIG. 3.

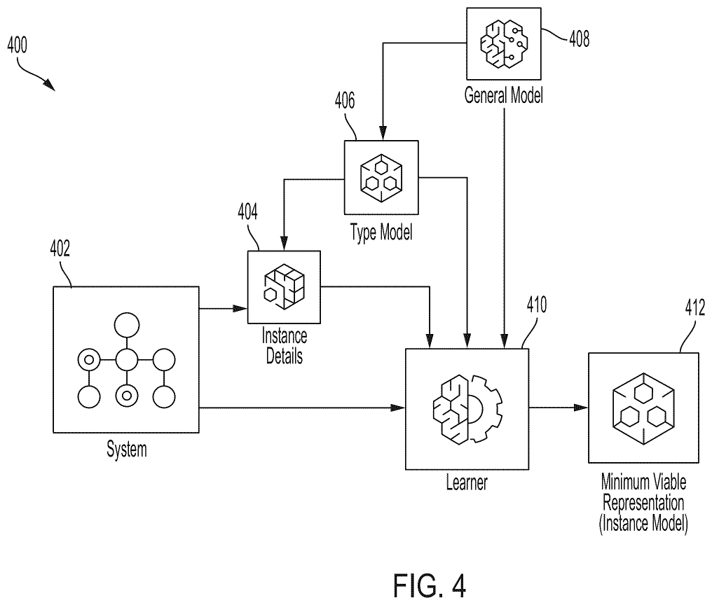

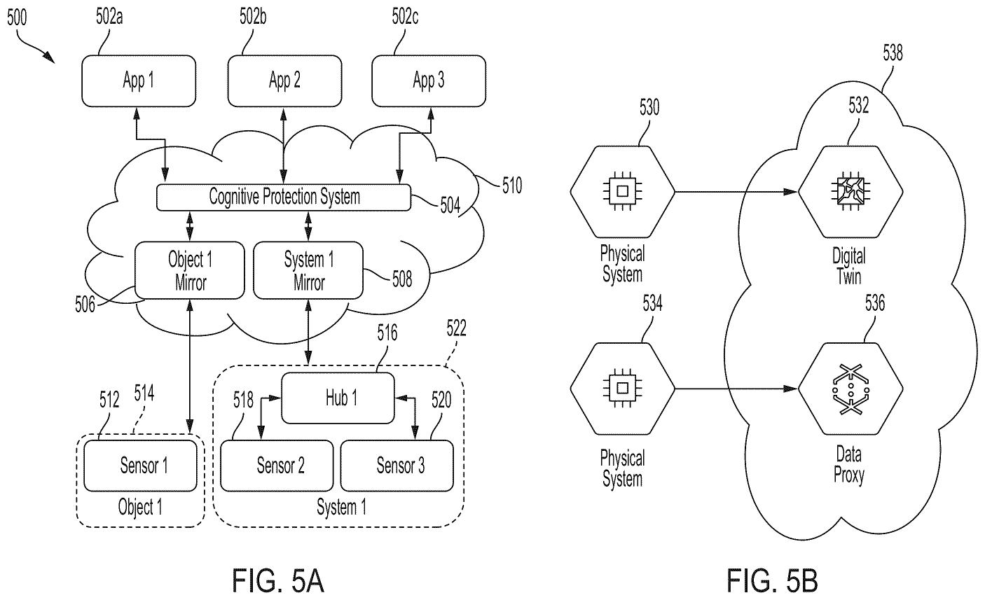

FIG. 4 shows a diagram 400 showing that when a system is mirrored, it first uses a generalized model and over time, models are adapted and leaned to mirror critical parameters with minimal resources according to examples of the present disclosure. FIG. 5A shows a diagram representation 500 where the mirrors (center), i.e., object mirror 1 506 and system mirror 1 508, represent Data Proxies within a Cloud computing environment according to examples of the present disclosure. The Proxy architecture allows diverse systems and applications to co-mingle with limited resource expenditure and few areas for interstitial weakness. FIG. 5B shows a diagram representation 550 where proxies store sparse representations of systems in remote computing environments, whereas Digital Twins offer higher resource intensity, more faithful mirrors according to examples of the present disclosure.

Once a system 405 has been uniquely identified, that identity may then be associated with a Data Proxy. This Proxy begins with a high-fidelity mirroring approach and observes system and interaction dynamics, adapting to learn an efficient state-space reconstruction model appropriate for the measurable and hidden attributes of the asset, in this case, a key. This is called the “minimum viable representation,” and it depends both on the system being mirrored and the end-use applications for its data. The adaptation from general to instance-specific model is shown in FIG. 4 while the Proxy architecture is shown in FIG. 5A and FIG. 5B. A learner 401 is provided by a general model 408, which is used to provide a type model 406, which is then used to provide instance details 404, which is provided by the system 402 and the type model 406. Learner 410 then provides the minimum viable representation (instance model) 412. In the case of a key, one might imagine that the process begins by identifying first that the system is a key, then a key for a specific lock type, then a key with a specific cut pattern, and then the instance of the key mating to that specific lock, with that cut pattern, with a certain level of wear.

As shown in FIG. 5A, one or more applications, such as App 1 502a, App 2 502b, App 3 502c, communicate with a cognitive protection system 504 and object mirror 1 506 and system mirror 1 508, which all reside in a cloud communication network 510. Object mirror 1 506 communicates with sensor 1 512 located with object 1 514. System mirror 1 508 communicates with hub 1, which then communicates with sensor 2 518 and sensor 3 520, which are all located with system 1 522. As shown in FIG. 5B, physical system 530 communicates with digital twin 532 and physical system 534 communicates with data proxy 536, where both digital twin 532 and data proxy 536 reside in a cloud communication network 538.

Proxies resulting from CPS sequencing will differ from conventional Digital Twins in that most Twin models are structured based on a particular asset type and tailored through manual data entry and other associative activities, whereas Proxies' originating assets are automatically identified and efficiently mirrored using a generalized, tailorable system model augmented with broader metadata reflecting provenance in addition to the system's current state. These Proxies are dynamically instantiated, rather than explicitly created, and integrated with DHT implementations, may be used to validate trusted identity more robustly than is presently feasible. This allows for the digitization of assets focused equally as much on whether a system “is” or “is not” that requested as much as faithfully mirroring that system throughout its lifecycle. Computationally-lightweight sequencing will allow all physical systems to have a unique digital identifier, irrespective of computational, sensory, or network constraints.

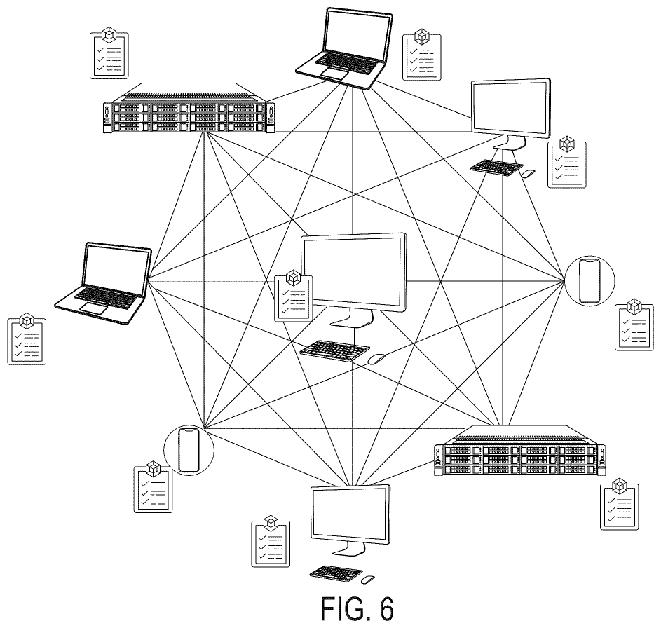

The CPS Sequence is associated with the Proxy as part of a universally-unique digital identifier. This identifier may then be used to associate an instance's Proxy with an entry on a Distributed Ledger, similarly to how barcodes or RFID tags are serialized as part of global standards. A representative distributed ledger is shown in FIG. 6; each node contains a copy of the asset manifest reflecting mirrored systems' CPS sequences and information on where to find and access the associated Data Proxy.

An overlying architecture, such as Twinbase can be adapted to provide a “wrapper” for Data Proxies through which DLT manifest entries may be resolved. The DLT itself may be exposed to an external API depending on application needs. In this manner, Proxies may be searched (with appropriate permission), analyzed, and engaged with at scale.

FIG. 6 shows a distributed ledger mirrors each digitized systems' CPS sequence, which in turn may be resolved to a specific Data Proxy mirroring system parameters according to examples of the present disclosure. A representative embodiment of a Proxy management scheme is shown in FIG. 6. Here, an asset's Owner may interface with an Asset Manager to assign permissions to assign permissions for Users to engage with their systems. The Asset Manager is a high-level API that “wraps” the various DLT's involved in representing CPS Sequences and associated Data Proxy mirrors, and may be public or private in nature and global or local in scale.

When a User wishes to interact with an asset's metadata or Proxy, the User makes a query with the Asset Manager, which then establishes a connection with the asset's CPS Sequence as stored within a DLT. The CPS Sequence is updated intermittently and reflects the system's Identity, as determined from sensor data at time of origin and stored within a DLT, and the system's Metadata, as determined by its provenance and current state (informed by a Proxy, which itself is a reflection of high-frequency sensor data).

When the User seeks to monitor the asset's identity or provenance for supply chain and other lower-frequency applications, the Asset Manager shares with the user the CPS Sequence itself. When the User wishes to engage with higher-frequency data, such as might be used in applications typically served by Digital Twins, the Asset Manager shares with the user a connection directly to the Proxy model itself. This is the same model used to estimate the system's current state and to update the Provenance when certain conditions are met. This maintains resource lightweightness and security.

In our case, the owner of multiple properties might store Proxies of each tenant's keys, and provide tenants access to the Asset Manager to track and manage the transfer of those keys to future tenants, or to recreate the keys from Proxy models in the event of a lockout. The same approach may be used for systems across scales, such as shipping containers, manufacturing equipment, or even factories-providing secure and efficient visibility while at the same time facilitating safe and secure access to richer system data to enable analytics and other applications.

This lightweight and scalable digital asset identification, mirroring, and tracking approach will provide enhanced insight into diverse constrained systems that are otherwise unable to self-report. Growing the mass-scale adoption of mass-scale digital mirroring has the potential to advance the transparency and accountability of diverse supply chains, while simultaneously addressing critical supply chain integrity threats.

The disclosed system's scalable approach is suitable for validating authenticity of diverse systems, even those with constrained compute and/or limited to no proprioceptive sensing capabilities. and also creating reasonably accurate digital mirrors suitable for analytics and other applications. This large-scale, lightweight and automated mirroring will improve access to trusted CPS and their benefits, bringing the advantages of Digital Twins (integrity, accountability, authenticity, transparency and insight) to technologically underserved industries. Further, storing unique identifiers in a distributed ledger will allow increased transparency into system history, ownership, and other factors, thereby enabling advanced supply chain and logistics optimization. Such a system provides social benefit by facilitating lifecycle cradle-to-grave environmental monitoring of non-sensored goods and enables the capture of newly-available data, supporting the creation of jobs for the workforce of the future.

However, there are challenges porting this approach to other physical assets at scale. First, there are environmental consequences to hashing blocks onto the Ethereum network: the energy required for a single transaction is more than a US household consumes in a day. Such consumption makes universal asset “tagging” infeasible. Another challenge is the increasing cost of listing an asset on the Ethereum network: to incentivize Ethereum miners to hash a block onto the Ethereum chain, a “gas” price is paid by the party seeking the transaction's verification. Should everyday objects be digitized, it is unlikely anyone would pay a today-typical $3.00 fee to have their pencil hashed to the blockchain.

DLT like directed acyclic graphs (DAGs) offer improved scalability. DAGs do not require hashing fees and need less processing power and therefore energy than conventional approaches. DAGs offer similar benefits of distributed, immutable consensus across a digital and/or cryptographic ledger and can be engaged for real-time data transfer and logging. However, DAGs have fewer established use cases and DAG NFT's must be developed. Other challenges to be addressed include developing a means to replace a “lost” token in a cryptographically secure way, and DAG's relatively-lower consensus security (33% attacks result in compromise).

Irrespective of the DLT chosen, the disclosed approach values security over privacy. Sensitive or private assets are not suitable for storage on a public distributed ledger; in these cases, privacy may be traded for security in the form of private blockchain instances. There is also a need to codify and standardize the reporting requirements for system-impacting events such that metadata might be accurately and comprehensively reflected for diverse systems.

Finally, the notion of identity must be better understood to create a system that manages unique and diverse assets effectively—that is, if elements of a component or system are replaced, is that system the same? These and other philosophical debates will be part and parcel with the development of any large-scale proof-of-concept for automated distributed asset management.

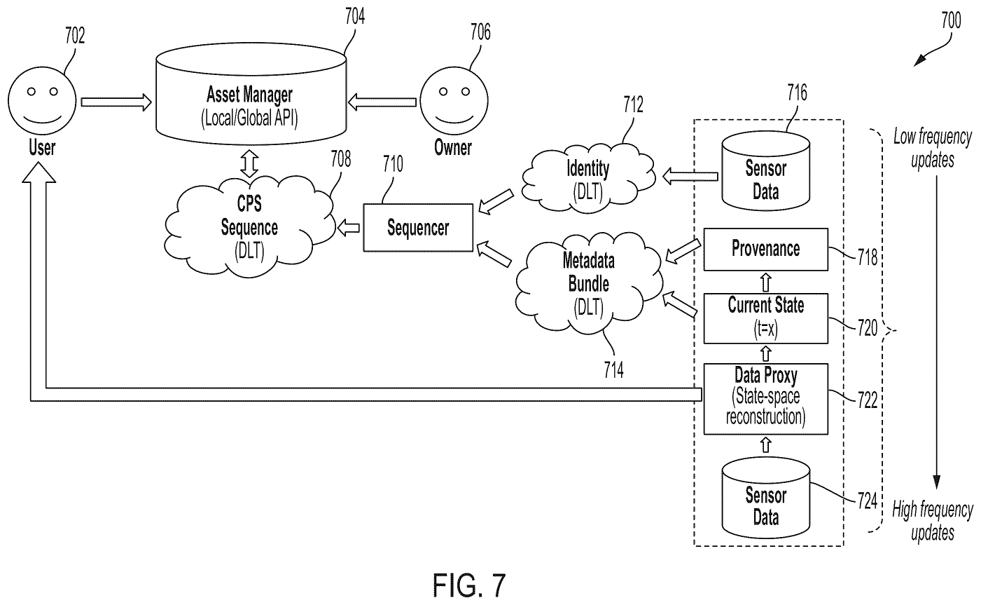

FIG. 7 shows a diagram 700 showing a representative interaction among asset owners and users of asset data according to examples of the present disclosure. An asset manager manages ownership and permissions, while mediating data access requests for identity, metadata, and Proxy-held information. User 702 and owner 706 communicate with asset manager 704, which comprises a local/global API. In some examples, asset manager 704 is a component, a service, or a feature provided by metaverse clearing house 106. In some examples, asset manager 704 is a separate component, service, or feature provided by another entity and/or service provider than metaverse clearing house 106. Asset manager 704 communicates with CPS sequency (DLT) 708. Sequencer 710 communicates with and provides sequence data to CPS sequence 708. Sequencer 710 communicates with a receives data from Identity (DLT) 712 and metadata bundle (DLT) 714. Sensor data 724 is provided to data proxy (state-space reconstruction) 722, which is then provided to current state (t=x) 720, which is provided to provenance 718. Sensor data 716 is provided to identity (DLT) 712 and provenance 718 and current state 720 is provided to metadata bundle (DLT) 714.

Diverse, distributed supply chains invite risk for counterfeit, compromise, or non-compliance. Consistent validation of the trusted identity and integrity of CPS in support of supervision, management, tracking and transferability mitigates this risk, improving trust in the complex systems comprising national critical functions. Attaching to this identity measures of current system state and provenance enable richer suites of asset management and supervision applications, as well as the development of system analytics and optimization today best suited for Digital Twinning approaches.

Deep Technology affordances that might facilitate large-scale asset identification and supervision, and building upon these, proposed the development of a system for automatically validating the identity and provenance of diverse, distributed systems. This system comprises distributed system identification and asset integrity tracking techniques built upon fundamental mechanical and software engineering capabilities to create and identify differentiating features for systems with limited internal sensing capabilities. A “CPS sequencing” can be used as a lightweight and scalable approach for CPS instance identification and automated metadata matching suitable for validating authenticity of diverse systems at scale, even those with constrained compute and/or sensing capabilities. Storing unique identifiers in a distributed ledger will allow increased transparency into system history, ownership, and other factors. These affordances, along with the approach's low resource requirements, will allow for the mass-scale adoption of digital mirroring solutions ill suited for conventional approaches-enabling pervasive identification (similar to RFID, QR codes) with the benefits of richer metadata and realtime insights (similar to those enabled by Digital Twins). Importantly, “sequencing the genome” of diverse CPS will create a corpus of data for differentiating among and uniquely identifying diverse systems with a range of sensing modalities.

Implemented well and at scale, the disclosed approach has the potential to facilitate automated system identification and the ability to pair an asset with a system-specific, immutable digital identifier. Identification and model-matching techniques will form a control loop validating an instance's authenticity and therefore provenance. This form of automated non-repudiable track-and-trace enables trust for CPS' use in critical supply chain and logistics applications related to healthcare, space systems and other national critical functions.

Storing unique identifiers with DLT will allow increased transparency and insight into system history, ownership, and other factors that could be critical to establishing a traceable audit trail, thereby enabling governance procedures. Such an approach may be readily adopted by environmental transparency efforts such as cradle-to-grave lifecycle tracking of non-sensored goods; moreover, it will provide logistics and supply chain information where previously there was none, leading to cross-domain insights that may enhance operational efficiency, safety, and security.

A representative system is disclosed that comprises an automated system identification, pervasive mirroring and system digitization, and mirror management with metadata that addresses challenges in architecture design related to defining identify, representing metadata, and improving system generalizability by using ultra-low-resource sequencing implementations, with optional integral “mining” components, such that asset identification and distributed ledger node service run on constrained edge devices directly, with sequencing serving as a form of proof-of-work. In this manner, classification, the distributed ledger, and cryptographic processes may be run entirely on the subset of instrumented devices with onboard computation, leading to scalability and resilience benefits. To further enhance the solution's applicability in sensitive domains, the disclosed system can operate on proprietary distributed ledgers that allow CPS identities and transactions to be made visible only to select entities holding an appropriate digital key.

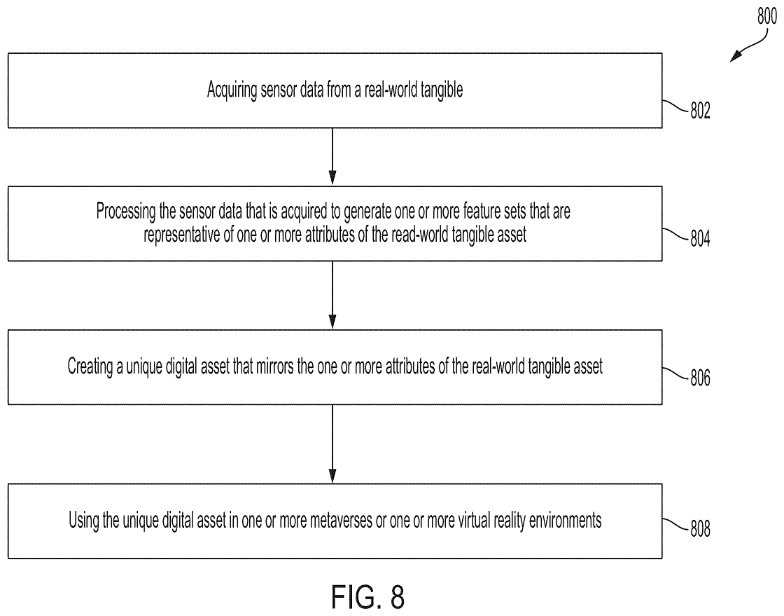

FIG. 8 shows a method 800 according to examples of the present disclosure. The method 800 comprises acquiring sensor data from a real-world tangible asset, as in 802. For example, the sensor data can be acquired from one or more proprioceptive sensors, one or more exterioceptive sensors, manually entered data, derived identifiable digital data, metadata, or combinations thereof.

The method 800 continues by processing the sensor data that is acquired to generate one or more feature sets that are representative of one or more attributes of the read-world tangible asset, as in 804. For example, the processing can comprise performing one or more frequency analysis processes, one or more cepstrum analytic processes, one or more filtering processes, one or more wavelet analysis processes, one or more spectral analysis processes, one or more image processing, one or more computer vision processing, or combinations thereof. For example, the one or more feature sets are resistant to perturbations so that one or more unique landmarks associated with the one or more attributes of the real-world tangible asset are uniquely identifiable. For example, the one or more unique landmarks are extractable without prior knowledge or human intervention.

The method 800 continues by creating a unique digital asset that mirrors the one or more attributes of the real-world tangible asset, as in 806. For example, the unique digital asset comprises a digital ledger that comprises information related to ownership of the unique digital asset and the real-world tangible asset. For examples, the unique digital asset can comprise a digital ledger that comprises information related to one or more rights provided by the unique digital asset and the real-world tangible asset. For examples, the unique digital asset can be a non-fungible token. For example, the digital ledger can comprise a blockchain.

In some examples, the method 800 can optionally further comprise using the unique digital asset in one or more metaverses or one or more virtual reality environments.

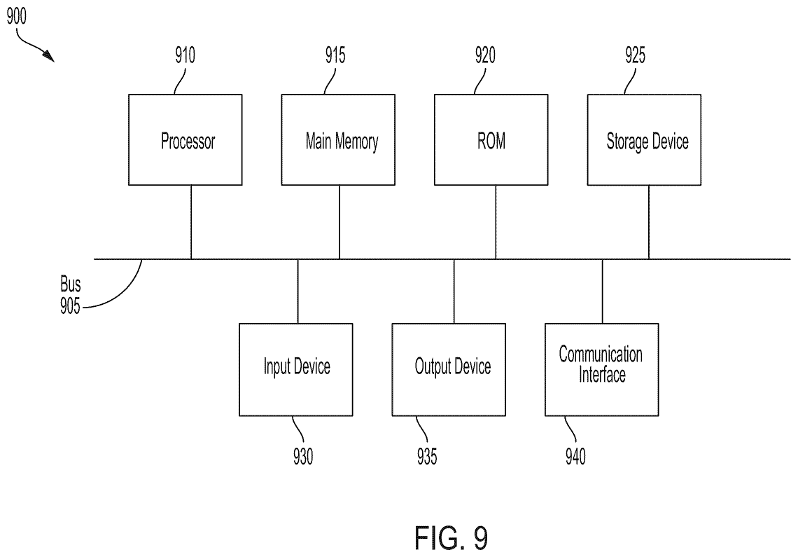

FIG. 9 illustrates example components of a device 900 that may be used within and/or by the various examples described. Device 900 may correspond to a user device, a network device, and/or a front-end or back-end server. Each of the user device, the network device, and/or the front-end or the back-end server may include one or more devices 900 and/or one or more components of device 900.

As shown in FIG. 9, device 900 may include a bus 905, a processor 910, a main memory 915, a read only memory (ROM) 920, a storage device 925, an input device 930, an output device 935, and a communication interface 940.

Bus 905 may include a path that permits communication among the components of device 900. Processor 910 may include a processor, a microprocessor, an application specific integrated circuit (ASIC), a field programmable gate array (FPGA), or another type of processor that interprets and executes instructions. Main memory 915 may include a random access memory (RAM) or another type of dynamic storage device that stores information or instructions for execution by processor 910. ROM 920 may include a ROM device or another type of static storage device that stores static information or instructions for use by processor 910. Storage device 925 may include a magnetic storage medium, such as a hard disk drive, or a removable memory, such as a flash memory.

Input device 930 may include a component that permits an operator to input information to device 900, such as a control button, a keyboard, a keypad, or another type of input device. Output device 935 may include a component that outputs information to the operator, such as a light emitting diode (LED), a display, or another type of output device. Communication interface 940 may include any transceiver-like component that enables device 900 to communicate with other devices or networks. In some implementations, communication interface 940 may include a wireless interface, a wired interface, or a combination of a wireless interface and a wired interface. In embodiments, communication interface 940 may receiver computer readable program instructions from a network and may forward the computer readable program instructions for storage in a computer readable storage medium (e.g., storage device 925).

Device 900 may perform certain operations, as described in detail below. Device 900 may perform these operations in response to processor 910 executing software instructions contained in a computer-readable medium, such as main memory 915. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into main memory 915 from another computer-readable medium, such as storage device 925, or from another device via communication interface 940. The software instructions contained in main memory 915 may direct processor 910 to perform processes that will be described in greater detail herein. Alternatively, hardwired circuitry may be used in place of or in combination with software instructions to implement processes described herein. Thus, implementations described herein are not limited to any specific combination of hardware circuitry and software.

In some implementations, device 900 may include additional components, fewer components, different components, or differently arranged components than are shown in FIG. 9.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may include a system, a method, and/or a computer program product at any possible technical detail level of integration. The computer program product may include a computer readable storage medium (or media) having computer readable program instructions thereon for causing a processor to carry out or execute aspects and/or processes of the present disclosure.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on a user's computer, partly on the user's computer, as a stand-alone software package, partly on the user's computer and partly on a remote computer or entirely on the remote computer or server.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In embodiments, a service provider could offer to perform the processes described herein. In this case, the service provider can create, maintain, deploy, support, etc., the computer infrastructure that performs the process steps of the disclosure for one or more customers. These customers may be, for example, any business that uses technology. In return, the service provider can receive payment from the customer(s) under a subscription and/or fee agreement and/or the service provider can receive payment from the sale of advertising content to one or more third parties.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the invention has been illustrated respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function.

Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of three A, B and C.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising:
acquiring sensor data from a real-world tangible asset;
processing the sensor data that is acquired to generate one or more feature sets that are representative of one or more attributes of the read-world tangible asset; and
creating a unique digital asset that mirrors the one or more attributes of the real-world tangible asset.

2. The method of claim 1, wherein the sensor data is acquired from one or more proprioceptive sensors, one or more exterioceptive sensors, manually entered data, derived identifiable digital data, metadata, or combinations thereof.

3. The method of claim 1, wherein the processing comprises performing one or more frequency analysis processes, one or more cepstrum analytic processes, one or more filtering processes, one or more wavelet analysis processes, one or more spectral analysis processes, one or more image processing, one or more computer vision processing, or combinations thereof.

4. The method of claim 1, wherein the one or more feature sets are resistant to perturbations so that one or more unique landmarks associated with the one or more attributes of the real-world tangible asset are uniquely identifiable.

5. The method of claim 4, wherein the one or more unique landmarks are extractable without prior knowledge or human intervention.

6. The method of claim 1, wherein the unique digital asset comprises a digital ledger that comprises information related to ownership of the unique digital asset and the real-world tangible asset.

7. The method of claim 1, wherein the unique digital asset comprises a digital ledger that comprises information related to one or more rights provided by the unique digital asset and the real-world tangible asset.

8. The method of claim 1, wherein the unique digital asset is a non-fungible token.

9. The method of claim 1, wherein the digital ledger comprises a blockchain.

10. The method of claim 1, further comprising using the unique digital asset in one or more metaverses or one or more virtual reality environments.

11. A computer system comprising:
a hardware processor;
a non-transitory computer readable medium that stores instructions that when executed by the hardware processor perform a method comprising:
acquiring sensor data from a real-world tangible asset;
processing the sensor data that is acquired to generate one or more feature sets that are representative of one or more attributes of the read-world tangible asset; and
creating a unique digital asset that mirrors the one or more attributes of the real-world tangible asset.

12. The computer system of claim 11, wherein the sensor data is acquired from one or more proprioceptive sensors, one or more exterioceptive sensors, manually entered data, derived identifiable digital data, metadata, or combinations thereof.

13. The computer system of claim 11, wherein the processing comprises performing one or more frequency analysis processes, one or more cepstrum analytic processes, one or more filtering processes, one or more wavelet analysis processes, one or more spectral analysis processes, one or more image processing, one or more computer vision processing, or combinations thereof.

14. The computer system of claim 11, wherein the unique digital asset comprises a digital ledger that comprises information related to ownership of the unique digital asset and the real-world tangible asset.

15. The computer system of claim 11, wherein the unique digital asset comprises a digital ledger that comprises information related to one or more rights provided by the unique digital asset and the real-world tangible asset.

16. A non-transitory computer readable medium that stores instructions that when executed by a hardware processor perform a method comprising:
acquiring sensor data from a real-world tangible asset;
processing the sensor data that is acquired to generate one or more feature sets that are representative of one or more attributes of the read-world tangible asset; and
creating a unique digital asset that mirrors the one or more attributes of the real-world tangible asset.

17. The non-transitory computer readable medium of claim 16, wherein the sensor data is acquired from one or more proprioceptive sensors, one or more exterioceptive sensors, manually entered data, derived identifiable digital data, metadata, or combinations thereof.

18. The non-transitory computer readable medium of claim 16, wherein the processing comprises performing one or more frequency analysis processes, one or more cepstrum analytic processes, one or more filtering processes, one or more wavelet analysis processes, one or more spectral analysis processes, one or more image processing, one or more computer vision processing, or combinations thereof.

19. The non-transitory computer readable medium of claim 16, wherein the unique digital asset comprises a digital ledger that comprises information related to ownership of the unique digital asset and the real-world tangible asset.

20. The non-transitory computer readable medium of claim 16, wherein the unique digital asset comprises a digital ledger that comprises information related to one or more rights provided by the unique digital asset and the real-world tangible asset.
